(19) United States
(12) Patent Application Publication
(10) Pub. No.: US 2013/0344362 A1
(43) Pub. Date: Dec. 26, 2013

(54) TEMPERATURE CONTROL OF GALVANIC CELLS WITH THE AID OF HEAT-CONDUCTING PLASTIC COMPOUNDS

(71) Applicants: Sven Robert Raisch, Stuttgart (DE); Dirk Schmiederer, Kornwestheim (DE)

(72) Inventors: Sven Robert Raisch, Stuttgart (DE); Dirk Schmiederer, Kornwestheim (DE)

(73) Assignee: ROBERT BOSCH GmbH, Stuttgart (DE)

(21) Appl. No.: 13/978,327

(22) PCT Filed: Nov. 10, 2011
(86) PCT No.: PCT/EP2011/069804

§ 371 Date: Sep. 16, 2013

(30) Foreign Application Priority Data
Jan. 4, 2011 (DE) 10 2011 002 415.8

(51) Int. Cl. H01M 10/48; H01M 10/50

(52) U.S. Cl. CPC H01M 10/482; H01M 10/5004
USPC 429/93; 429/120

(57) ABSTRACT

A temperature-controlling plate and a plastic housing for one or multiple galvanic cell(s) is provided. The one or more multiple galvanic cells can be at least one of lithium cells and lithium-ion cells. To improve the temperature control of the cells and to reduce costs and weight, the temperature-controlling plate or the plastic housing includes at least one section provided for heat dissipation which is formed from a plastic compound which includes at least one additive for increasing the thermal conductivity.

### FIELD

The present invention relates to a temperature-controlling plate and a plastic housing for a galvanic cell, as well as a corresponding battery system.

### BACKGROUND INFORMATION

Lithium-ion cells customarily have a metallic shell made of aluminum. Multiple, for example, six to eight, such cells are usually installed to form a battery module so that, for example, three or more, such battery modules may in turn be installed to form a battery pack.

For the purpose of temperature control, the battery modules or battery packs are usually mounted on a metallic cooling plate. An electrical insulator is mounted between the cells and the metallic plate to avoid a short circuit between the cells and the metallic cooling plate. Each individual cell is customarily separately wired to a cell monitoring device for monitoring the state of charge and the operating state.

### SUMMARY

Example embodiments of the present invention provide for a temperature-controlling plate for controlling the temperature of one or multiple galvanic cell(s), e.g., lithium cells or lithium-ion cells, having, or optionally not having, a metallic cell shell which includes at least one temperature-controlling medium channel for conducting a temperature-controlling medium through the temperature-controlling plate. These types of temperature-controlling plates can also be referred to as cooling plates.

According to example embodiments of the present invention, at least one section of the temperature-controlling plate which is provided for heat dissipation and which at least partially delimits the at least one temperature-controlling medium channel is formed from a plastic compound which includes at least one additive for increasing the thermal conductivity.

According to example embodiments of the present invention, a plastic compound may be understood to mean a composite material which, in addition to one or multiple base polymers, includes at least one additive for modifying the base polymer properties.

According to example embodiments of the present invention, an additive for increasing the thermal conductivity may be understood to mean an additive which increases the specific thermal conductivity of the plastic compound relative to the specific thermal conductivity of the plastic compound without the thermal conductivity-increasing additive.

According to example embodiments of the present invention, as a result of the temperature-controlling plate, the situation advantageously may be achieved that the heat resulting during charging, for example, no longer has to first be transmitted from the cell shell into the electrical insulator and from there to a cooling plate. Instead, the heat may be transmitted from the cell shell or even the cell itself directly to the temperature-controlling medium or cooling medium via the heat-conducting plastic compound. The resistance of the heat conduction path may thus advantageously be greatly lowered, and the weight reduced.

The temperature-controlling medium may be a liquid, gaseous, or solid temperature-controlling medium. Or, for example, the temperature-controlling medium may be a liquid or gaseous temperature-controlling medium.

Within the scope of an example embodiment of the temperature-controlling plate, the at least one temperature-controlling medium channel is partially delimited by at least one further section of the temperature-controlling plate which is formed from one or multiple other material(s), for example one or multiple plastic(s), plastic compound(s), and/or plastic-metal composite material(s). Thus, the temperature-controlling plate may advantageously be equipped with further functions explained below, and the costs and the weight of the battery to be equipped with the temperature-controlling plate may be optimized, in particular reduced, overall.

Within the scope of an example embodiment of the temperature-controlling plate, the at least one further section of the temperature-controlling plate includes only plastics, plastic compounds, or plastic-metal composite materials which include no additive for increasing the thermal conductivity. In particular, the at least one further section of the temperature-controlling plate may be formed from a plastic or plastic compound material which includes no additive for increasing the thermal conductivity. The weight and the costs may thus in particular be optimized, in particular reduced, in an advantageous manner.

Within the scope of an example embodiment of the temperature-controlling plate, the at least one temperature-controlling medium channel is formed by two half-shells which are put together. Both half-shells may have a structure for jointly or separately forming the temperature-controlling medium channel, or also only one of the two half-shells may have a structure which forms the temperature-controlling medium channel, while the other half-shell has no structure of this type. The manufacture of the temperature-controlling plate according to an example embodiment of the present invention may thus be advantageously simplified. For example, one half-shell has a plastic compound which includes at least one additive for increasing the thermal conductivity. The other half-shell, for example, may include no additive for increasing the thermal conductivity.

The two half-shells may have different sizes, different designs, and different weights. Therefore, the term “half-shell” should not be construed to mean that the two half-shells are each the exact half of a whole.

Within the scope of an example embodiment of the temperature-controlling plate, the temperature-controlling plate is designed for controlling the temperature of two or more galvanic cells, e.g., the galvanic cells of a battery module, for example ≧4 to <12, and/or for example ≧6 to ≦8, galvanic cells. This has the advantage that the individual battery modules may be separately assembled and arranged in adaptation to the available space, which for an entire battery pack composed of multiple battery modules is not possible when a shared cooling plate is used.

According to embodiments of the present invention, the section delimiting the temperature-controlling channel, which is provided for heat dissipation, is formed from a plastic compound which, measured at 20° C. ambient temperature and 50% relative humidity, has a specific thermal conductivity A greater than or equal to 0.5 W/(m·K), e.g., greater than or equal to 0.7 W/(m·K), for example greater than or equal to 1 W/(m·K), and an electrical resistance ρ greater than or equal to 1·10⁻⁵ Ω·m, e.g., greater than or equal to 1·10⁻¹ Ω·m, e.g., greater than or equal to 1·10⁴ Ω·m.

The additive for increasing the thermal conductivity, measured at 20° C. ambient temperature and 50% relative humidity, for example, has a specific thermal conductivity λ greater than or equal to 10 W/(m·K), e.g., greater than or equal to 20 W/(m·K), for example, greater than or equal to 50 W/(m·K), and/or a specific electrical resistance ρ greater than or equal to 1·10⁻⁵ Ω˜m, e.g., greater than or equal to 1·10⁻¹ Ω·m, for example, greater than or equal to 1·10⁴ Ω·m.

For example, the additive for increasing the thermal conductivity may be a ceramic material. For example, the additive for increasing the thermal conductivity may be boron nitride, aluminum oxide, aluminum hydroxide, magnesium hydroxide, or a combination thereof.

Within the scope of an example embodiment of the temperature-controlling plate, the temperature-controlling plate is manufactured by an injection molding process and/or an extrusion process and/or a deep-drawing process. Due to the high degree of geometric freedom in these plastic processing methods, the temperature-controlling medium channels, electrical lines, electrical cell monitoring devices, and electrical contacting points may advantageously likewise be integrated into the temperature-controlling plate, and their design may be integrated into the injection molding, extrusion, or deep-drawing cycle, so that the process chain may be shortened.

In principle, the electrical contacting of the cells according to the related art may be achieved via wiring or subsequently installed metallic lines.

However, the temperature-controlling plate may also include one or multiple electrical line(s). These may in particular be integrated into the temperature-controlling plate. For example, the electrical lines may be formed with the aid of MID technology, for example by a metal-plating process.

The integration of the electrical contacting into the temperature-controlling plate has the advantage that complicated-to-manufacture wiring of the individual cells in a module or pack or for a cell monitoring device or for contacting the cells may be dispensed with, and instead the electrical contacting may advantageously be implemented in mass production. Thus, the process chain may be shortened overall and the manufacturing costs reduced. In addition, the overall installation space required for the battery system to be manufactured as well as its weight may thus be optimized, in particular reduced.

Within the scope of another specific embodiment of the temperature-controlling plate, the temperature-controlling plate includes at least one electrical line, in particular in the form of a temperature-controlling plate section which is provided for the electrical line or conduction, which is formed from an electrically self-conducting polymer or polymer mixture, and/or a plastic compound including at least one additive for increasing the electrical conductivity, and/or a metal-containing material.

The electrically self-conducting polymer or polymer mixture may include, for example, polyacetylene, polyaniline, polyparaphenylene, polypyrrole, and/or polythiophene. The additive for increasing the electrical conductivity may include, for example, graphite, carbon black, aluminum, copper, silver, or a combination thereof.

The metal-containing material may include, for example, aluminum, copper, silver, zinc, tin, or a combination of these.

Within the scope of an example embodiment of the temperature-controlling plate, the at least one electrical line is formed by extruding the electrically self-conducting polymer or polymer mixture and/or the plastic compound which includes at least one additive for increasing the electrical conductivity, and/or the metal-containing material in another material or multiple other materials of the temperature-controlling plate.

This provides an option for implementing or integrating electrical lines in/into the temperature-controlling plate in a particularly simple manner.

However, the at least one electrical line may also be implemented in some other way.

Within the scope of an example embodiment of the temperature-controlling plate, the temperature-controlling plate includes at least one electrical line which is formed by extrusion coating of a metallic line element, for example a wire or mesh, with another material or multiple other materials of the temperature-controlling plate.

This provides a further option for implementing or integrating electrical lines in/into the plastic housing in a particularly simple manner.

Within the scope of an example embodiment of the temperature-controlling plate, the temperature-controlling plate includes at least one electrical cell monitoring device for monitoring the state of charge and/or operating state of one or multiple galvanic cell(s). The at least one electrical cell monitoring device may, for example, be integrated into the temperature-controlling plate. For example, the cell monitoring device may include electrical lines which are formed as described above. For example, the at least one cell monitoring device may be formed, at least partially, with the aid of MID technology, for example using a metal-plating process. The incorporation of cell monitoring devices likewise has the advantages explained in conjunction with the electrical lines.

Within the scope of an example embodiment of the temperature-controlling plate, the temperature-controlling plate includes at least two electrical contacting devices for electrically contacting one or multiple galvanic cell(s). The contacting devices may be partially integrated into the temperature-controlling plate. In particular, the contacting devices may include electrical lines which are formed as described above. For example, the contacting devices may be formed, at least partially, with the aid of MID technology, for example using a metal-plating process. The incorporation of contacting devices likewise has the advantages explained in conjunction with the electrical lines.

In an example embodiment of the present invention, the temperature-controlling plate may include at least one temperature-controlling medium inlet connection for introducing a liquid or gaseous temperature-controlling medium into the temperature-controlling medium channel(s), and at least one temperature-controlling medium outlet connection for discharging the liquid or gaseous temperature-controlling medium from the temperature-controlling medium channel(s).

With regard to further advantages and features of the temperature-controlling plate according to the present invention, explicit reference is hereby made to the explanations in conjunction with the plastic housing according to the present invention, the battery system according to the present invention, and the description of the figures.

The present invention relates to a plastic housing for one or multiple galvanic cell(s), for example, lithium cells and/or lithium-ion cells, for example, having, or optionally not having, a metallic cell shell.

According to the present invention, at least one section of the plastic housing provided for heat dissipation is formed from a plastic compound which includes at least one additive for increasing the thermal conductivity.

The plastic housing according to the present invention has the advantage that the heat resulting during charging, for example, no longer has to first be transmitted from the cell shell into the electrical insulator and from there to a cooling plate; instead, the heat may be transmitted from the cell shell or even the cell itself, optionally directly, to the temperature-controlling medium or cooling medium via the heat-conducting plastic compound. The resistance of the heat conduction path may thus advantageously be greatly lowered, and the weight reduced.

In principle, it is possible for the at least one section provided for heat dissipation to be the area of the plastic housing provided for installation on a conventional cooling plate.

Within the scope of an example embodiment of the plastic housing, however, the at least one section which is provided for heat dissipation is provided for conducting heat from the cell, and delimits at least one temperature-controlling medium channel for conducting, for example, liquid and/or gaseous, temperature-controlling medium, at least partially, through the plastic housing.

Within the scope of an example embodiment of the plastic housing, the at least one section which is provided for heat dissipation is part of a cover, e.g., plate-shaped, of the plastic housing. This has the advantage that a good temperature-controlling effect may be achieved with low material costs and low weight by using the heat-conducting plastic compound.

In embodiments of the present invention, a cover may, for example, be understood to mean a housing component which is designed to close off one or multiple other housing component(s), forming a closed housing. The term “cover” should not be construed in a limiting manner concerning the orientation of the housing component referred to as a cover with regard to the gravitational direction. Thus, a housing component which is designed to close off one or multiple other housing component(s), forming a closed housing at the top or also at the sides or the bottom, may also be understood to mean a cover.

For example, the temperature-controlling plate according to an embodiment of the present invention may be the plate-shaped cover of the plastic housing, which has the at least one section provided for heat dissipation.

Alternatively or additionally, however, the at least one section which is provided for heat dissipation and/or which delimits at least one temperature-controlling medium channel, and/or the at least one further section which is provided for heat dissipation and/or which delimits at least one temperature-controlling medium channel, may be integrated into the plastic housing, e.g., into the base body of the plastic housing.

Within the scope of an example embodiment of the plastic housing, the plastic housing is designed for accommodating two or more galvanic cells, e.g., the galvanic cells of a battery module, for example ≧4 to ≦12, and/or for example ≧6 to ≦8, galvanic cells. This has the advantage that the individual battery modules may be separately assembled and arranged in adaptation to the available space, which for an entire battery pack composed of multiple battery modules is not possible when a shared cooling plate is used.

In an embodiment of the present invention, the section provided for heat dissipation is formed from a plastic compound which, measured at 20° C. ambient temperature and 50% relative humidity, has a specific thermal conductivity λ greater than or equal to 0.5 W/(m·K), e.g., greater than or equal to 0.7 W/(m·K), for example greater than or equal to 1 W/(m·K), and a specific electrical resistance ρ greater than or equal to 1·10⁻⁵ Ω·m, e.g., greater than or equal to 1·10⁻¹ Ω·m, for example greater than or equal to 1·10⁴ Ω·m.

The additive for increasing the thermal conductivity, measured at 20° C. ambient temperature and 50% relative humidity, may in particular have a specific thermal conductivity λ greater than or equal to 10 W/(m·K), e.g., greater than or equal to 20 W/(m·K), for example greater than or equal to 50 W/(m·K), and/or a specific electrical resistance p greater than or equal to 1·10⁻⁵ Ω·m, e.g., greater than or equal to 1·10⁻¹ Ω·m, for example greater than or equal to 1·10⁴ Ω·m.

For example, the additive for increasing the thermal conductivity may be a ceramic material. For example, the additive for increasing the thermal conductivity may be boron nitride, aluminum oxide, aluminum hydroxide, magnesium hydroxide, or a combination thereof.

Within the scope of an example embodiment of the plastic housing, the plastic housing is manufactured by an injection molding process and/or an extrusion process and/or a deep-drawing process. Due to the high degree of geometric freedom in these plastic processing methods, the temperature-controlling medium channels, electrical lines, electrical cell monitoring devices, and electrical contacting points may advantageously likewise be integrated into the plastic housing, and their design may be integrated into the injection molding, extrusion, or deep-drawing cycle, so that the process chain may be shortened. In addition, multiple different housing elements may be easily manufactured in one piece, two pieces, or optionally in multiple pieces. If the plastic housing includes two or more housing parts, for example a housing base body and a housing cover, these parts may be connected, for example, by welding or gluing, or by mechanical processes such as screwing, clipping, etc. In the case of injection molding, the galvanic cells may be extrusion-coated directly with the plastic housing, or may also be subsequently inserted into the plastic housing.

In principle, the electrical contacting of the cells according to the related art may also be achieved by wiring or subsequently installed metallic lines.

In an embodiment of the present invention, the plastic housing includes at least one electrical line. For example, the at least one electrical line is integrated into the plastic housing. For example, the at least one electrical line may be formed with the aid of MID technology, for example, by a metal-plating process.

The integration of the electrical contacting into the plastic housing has the advantage that complicated-to-manufacture wiring of the individual cells in a module or pack or for a cell monitoring device or for contacting the cells outside the housing may be dispensed with, and instead the electrical contacting may advantageously be implemented in mass production. Thus, the process chain may be shortened overall and the manufacturing costs reduced. In addition, the overall installation space required for the battery system to be manufactured as well as its weight may thus be optimized, e.g., reduced.

Within the scope of an example embodiment of the plastic housing, the plastic housing includes at least one electrical line, e.g., in the form of a housing section provided for the electrical line, which is formed from an electrically self-conducting polymer or polymer mixture, and/or a plastic compound including at least one additive for increasing the electrical conductivity, and/or a metal-containing material.

The electrically self-conducting polymer or polymer mixture may include, for example, polyacetylene, polyaniline, polyparaphenylene, polypyrrole, and/or polythiophene. The additive for increasing the electrical conductivity may include, for example, graphite, carbon black, aluminum, copper, silver, or a combination thereof. The metal-containing material may include, for example, aluminum, copper, silver, zinc, tin, or a combination.

Within the scope of an example embodiment of the plastic housing, the at least one electrical line is formed by extruding the electrically self-conducting polymer or polymer mixture and/or the plastic compound which includes at least one additive for increasing the electrical conductivity, and/or the metal-containing material in another material or multiple other materials of the plastic housing.

This provides an option for implementing or integrating electrical lines in/into the plastic housing in a particularly simple manner.

In embodiments of the present invention, the at least one electrical line may also be implemented in some other way.

In embodiments of the present invention, the plastic housing includes, for example, at least one electrical line which is formed by extrusion coating of a metallic line element, for example, a wire or mesh, with another material or multiple other materials of the plastic housing.

This provides a further option for implementing or integrating electrical lines in/into the plastic housing in a particularly simple manner.

Within the scope of an example embodiment of the plastic housing, the plastic housing includes at least one electrical cell monitoring device for monitoring the state of charge and/or operating state of one or multiple galvanic cell(s). The at least one electrical cell monitoring device may be integrated into the plastic housing. For example, the cell monitoring device may include electrical lines which are formed as described above. For example, the at least one cell monitoring device may be formed, at least partially, with the aid of MID technology, for example using a metal-plating process. The incorporation of cell monitoring devices likewise has the advantages explained in conjunction with the electrical lines.

Within the scope of another specific embodiment of the plastic housing, the plastic housing includes at least two electrical contacting devices for electrically contacting one or multiple galvanic cell(s) situated in the plastic housing. The contacting devices may be partially integrated into the plastic housing. For example, the contacting devices may include electrical lines which are formed as described above. For example, the contacting devices may be formed, at least partially, with the aid of MID technology, for example, using a metal-plating process. The incorporation of contacting devices likewise has the advantages explained in conjunction with the electrical lines.

Within the scope of an example embodiment of the plastic housing, the at least two electrical contacting devices are situated on and/or in that side of the plastic housing which is opposite from the section of the plastic housing provided for heat dissipation. Thus, the battery system to be manufactured may advantageously be installed in a particularly space-saving manner.

Within the scope of an example embodiment of the plastic housing, the plastic housing has at least one thermally conductive adhesive and/or one thermally conductive foil which is or which may be situated, e.g., adjacently, between the at least one section provided for heat dissipation and at least one galvanic cell. The heat dissipation may thus be advantageously improved. Since the thermally conductive adhesive or the thermally conductive foil is used essentially for tolerance compensation and not for electrical insulation, the thermally conductive adhesive or the thermally conductive foil may have a very thin design, so that the overall weight of the system is not significantly increased.

In addition, for example, the plastic housing may have at least one further housing section, formed from a plastic or plastic compound, which includes no additive for increasing the electrical conductivity. The weight and the costs of the plastic housing may thus be advantageously optimized, e.g., reduced.

Within the scope of an example embodiment of the plastic housing, the plastic housing is designed for accommodating two or more galvanic cells.

With regard to further advantages and features of the plastic housing according to the present invention, explicit reference is hereby made to the explanations in conjunction with the temperature-controlling plate according to the present invention, the battery system according to the present invention, and the description of the figures.

Embodiments of the present invention provide a battery system, e.g., a battery or battery module, which includes a temperature-controlling plate according to the present invention and/or a plastic housing according to the present invention and one or multiple galvanic cell(s), e.g., lithium cells and/or lithium-ion cells.

Within the meaning of the present invention, a battery is understood to mean not only primary batteries, also colloquially referred to as batteries, but also in particular secondary batteries, also colloquially referred to as accumulators.

In embodiments of the present invention, the battery system is a battery module which includes, for example, ≧4 to ≦12, and/or for example ≧6 to ≦8, galvanic cells. This has the advantage that the battery module may be individually assembled with other battery modules and arranged in adaptation to the available space, which for an entire battery pack composed of multiple battery modules is not possible when a shared cooling plate is used.

The galvanic cells may optionally have a metallic cell shell made of, e.g., aluminum.

With regard to further advantages and features of the battery system according to the present invention, explicit reference is hereby made to the explanations in conjunction with the temperature-controlling plate according to the present invention, the plastic housing according to the present invention, and the description of the figures.

### BRIEF DESCRIPTION OF THE DRAWINGS

FIG. 1 shows a schematic cross section of one specific embodiment of a temperature-controlling plate according to the present invention

FIG. 2a shows a schematic cross section of one specific embodiment of a plastic housing according to the present invention.

FIG. 2b shows a schematic cross section of another specific embodiment of a plastic housing according to the present invention.

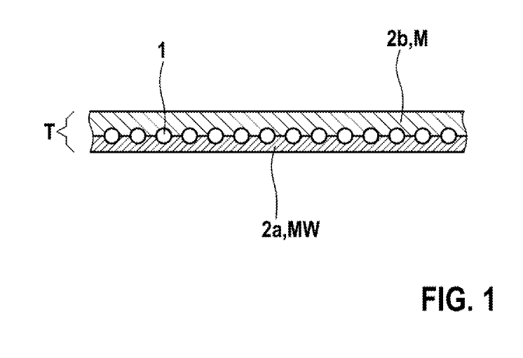

FIG. 1 shows an example embodiment of a temperature-controlling plate T according to the present invention for controlling the temperature of one or multiple galvanic cell(s) Z, e.g., lithium cells and/or lithium-ion cells, having a metallic shell. FIG. 1 shows that temperature-controlling plate T includes multiple temperature-controlling medium channels 1 for conducting a temperature-controlling medium through temperature-controlling plate T. FIG. 1 shows that temperature-controlling plate T has a section 2a which is provided for heat dissipation and which partially delimits temperature-controlling medium channels 1. According to the present invention, this section is formed from a plastic compound MW which includes at least one additive for increasing the thermal conductivity.

FIG. 1 illustrates that temperature-controlling medium channels 1 are partially delimited by a further section 2b of temperature-controlling plate T which is formed from one or multiple other material(s) M, for example one or multiple plastic(s), plastic compound(s), and/or plastic-metal composite material(s). For example, section 2b is formed from one or multiple plastic(s) or plastic compound(s) or plastic-metal material(s) M which include no additive for increasing the thermal conductivity. The costs and the weight of temperature-controlling plate T may thus be advantageously optimized.

FIG. 1 shows, for example, that temperature-controlling medium channels 1 are formed by two structured half-shells 2a, 2b which are put together, one half-shell 2a containing plastic compound MW which has an additive for increasing the thermal conductivity, and other half-shell 2b containing plastic compound M which has no additive for increasing the thermal conductivity.

The angled lateral delimiting lines show that temperature-controlling plate T according to the present invention may be designed to simultaneously control the temperature of multiple, for example, four to twelve, galvanic cells Z, for example, the cells of a battery pack.

The example embodiment shown in FIG. 1 may also include, for example, one or multiple electrical line(s), cell monitoring device(s), contacting device(s), temperature-controlling medium inlet connection(s), and/or temperature-controlling medium outlet connection(s) which are described in the general section, but not illustrated in FIG. 1 for the sake of clarity.

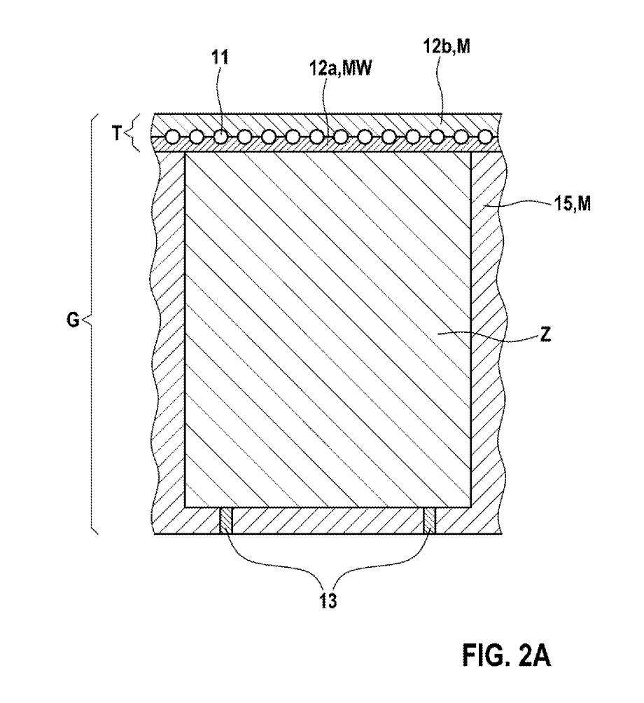

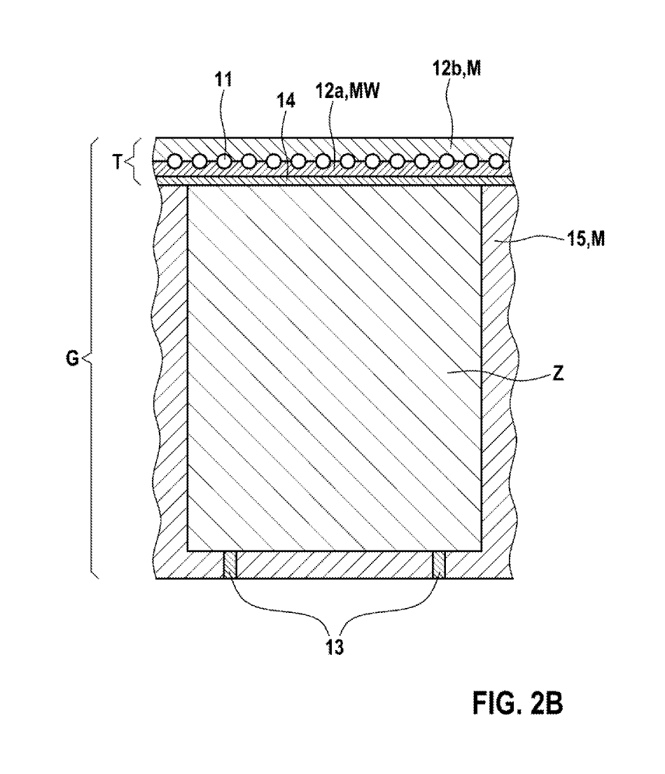

FIG. 2a shows that within the scope of this present embodiment, for one or multiple galvanic cell(s) Z, for example having a metallic cell shell, plastic housing G according to the present invention has a section 12a which is provided for heat dissipation and which is formed from a plastic compound MW which includes at least one additive for increasing the thermal conductivity. FIG. 2a shows that section 12a provided for heat dissipation is part of a, e.g., plate-shaped, cover of plastic housing G. For example, a temperature-controlling plate T according to the present invention may be used as a cover.

FIG. 2a illustrates that section 12a, provided for heat dissipation, together with section 12b is an integral part of a temperature-controlling medium-conducting component, in particular a temperature-controlling plate T which functions as a housing cover, having temperature-controlling medium channels 11 which are delimited by sections 12a and 12b. Section 12a, which is provided for heat dissipation, and section 12b, which is formed from a plastic or plastic compound M which includes no additive for improving the thermal conductivity, are designed as half-shells which together form and delimit temperature-controlling medium channels 11.

FIG. 2a also shows that plastic housing G, e.g., the housing base body, additionally includes two electrical contacting devices 13 for electrically contacting one or multiple galvanic cell(s) Z situated in plastic housing G, the electrical contacting devices being situated on and/or in that side of plastic housing G which is opposite from section 12a of the plastic housing provided for heat dissipation.

FIG. 2a shows that the plastic housing has a housing base body in addition to the above-described housing cover. In order to optimize the weight and the costs of plastic housing G, the housing base body may have sections 15 which are formed from a plastic or plastic compound M which includes no additive for increasing the thermal conductivity.

The angled lateral delimiting lines show that plastic housing G according to the present invention may have further compartments for galvanic cells Z which have a design similar to the shown compartment.

The example embodiment shown in FIG. 2b differs from the example embodiment shown in FIG. 2a essentially in that the plastic housing includes a thermally conductive adhesive or thermally conductive foil 14 which is adjacently situated between section 12a of plastic housing G, provided for heat dissipation, and galvanic cell Z.

The example embodiments shown in FIGS. 2a and 2b may also include, for example, one or multiple electrical line(s), cell monitoring device(s), temperature-controlling medium inlet connection(s), and/or temperature-controlling medium outlet connection(s) which are described in the general section, but not illustrated in FIGS. 2a and 2b for the sake of clarity.

1-21. (canceled)

22. A temperature-controlling plate for controlling the temperature of one or multiple galvanic cell(s), including at least one temperature-controlling medium channel for conducting a temperature-controlling medium through the temperature-controlling plate, wherein at least one section of the temperature-controlling plate which is provided for heat dissipation and which at least partially delimits the at least one temperature-controlling medium channel is formed from a plastic compound which includes at least one additive for increasing the thermal conductivity.

23. The temperature-controlling plate as recited in claim 22,
wherein the at least one temperature-controlling medium channel is partially delimited by at least one further section of the temperature-controlling plate which is formed from one or multiple other material(s).

24. The temperature-controlling plate as recited in claim 23,
wherein the at least one further section of the temperature-controlling plate is formed from one of a plastic and a plastic compound which includes no additive for increasing the thermal conductivity.

25. The temperature-controlling plate as recited in claim 23,
wherein the at least one temperature-controlling medium channel is formed from two half-shells which are put together, one half-shell containing a plastic compound which includes at least one additive for increasing the thermal conductivity, and the other half-shell including no additive for increasing the thermal conductivity.

26. The temperature-controlling plate as recited in claim 22,
wherein the temperature-controlling plate is designed for controlling the temperature of two or more galvanic cells.

27. The temperature-controlling plate as recited in claim 22,
wherein the temperature-controlling plate is manufactured by at least one of an injection molding process, an extrusion process, and a deep-drawing process.

28. The temperature-controlling plate as recited in claim 22,
wherein the temperature-controlling plate includes at least one electrical line, in the form of a temperature-controlling plate section which is provided for the electrical conduction, which is formed from an electrically self-conducting polymer or polymer mixture, and/or a plastic compound including at least one additive for increasing the electrical conductivity, and/or a metal-containing material.

29. The temperature-controlling plate as recited in claim 28,
wherein the at least one electrical line is formed by extruding the electrically self-conducting polymer or polymer mixture and/or the plastic compound which includes at least one additive for increasing the electrical conductivity, and/or the metal-containing material into another material or multiple other materials of the temperature-controlling plate.

30. The temperature-controlling plate as recited in claim 22,
wherein the temperature-controlling plate includes at least one electrical line which is formed by extrusion coating of a metallic line element with at least one other material of the temperature-controlling plate.

31. The temperature-controlling plate as recited in claim 22,
wherein the temperature-controlling plate includes
at least one electrical cell monitoring device for monitoring the state of charge and/or operating state of one or multiple galvanic cell(s), and/or
at least two electrical contacting devices for electrically contacting one or multiple galvanic cell(s).

32. A plastic housing for one or multiple galvanic cell(s), wherein at least one section of the plastic housing which is provided for heat dissipation is formed from a plastic compound which includes at least one additive for increasing the thermal conductivity.

33. The plastic housing as recited in claim 32,
wherein the at least one section which is provided for heat dissipation at least partially delimits at least one temperature-controlling medium channel for conducting a temperature-controlling medium through the plastic housing.

34. The plastic housing as recited in claim 32,
wherein the at least one section which is provided for heat dissipation is part of a cover of the plastic housing.

35. The plastic housing as recited in claim 22,
wherein the plastic housing is designed for accommodating two or more galvanic cells, wherein the two or more galvanic cells include at least one of galvanic cells of a battery module, ≧4 to ≦12 galvanic cells, and ≧6 to ≦8 galvanic cells.

36. The plastic housing as recited in claim 32,
wherein the plastic housing is manufactured by at least one of an injection molding process, an extrusion process, and a deep-drawing process.

37. The plastic housing as recited in claim 32,
wherein the plastic housing includes at least one electrical line, in the form of a housing section provided for the electrical conduction, which is formed from an electrically self-conducting polymer or polymer mixture and/or a plastic compound including at least one additive for increasing the electrical conductivity, and/or a metal-containing material.

38. The plastic housing as recited in claim 36,
wherein the at least one electrical line is formed by extruding the electrically self-conducting polymer or polymer mixture and/or the plastic compound which includes at least one additive for increasing the electrical conductivity, and/or the metal-containing material into another material or multiple other materials of the plastic housing.

39. The plastic housing as recited in claim 32,
wherein the plastic housing includes at least one electrical line which is formed by extrusion coating of a metallic line element with at least one of another material and multiple other materials of the plastic housing.

40. The plastic housing as recited in claim 32,
wherein the plastic housing includes
at least one electrical cell monitoring device for monitoring the state of charge and/or operating state of one or multiple galvanic cell(s), and/or
at least two electrical contacting devices for electrically contacting one or multiple galvanic cell(s) situated in the plastic housing.

41. The plastic housing as recited in claim 40,
wherein the at least two electrical contacting devices are situated on and/or in the side of the plastic housing which is opposite from the at least one section of the plastic housing provided for heat dissipation.

42. The plastic housing as recited in claim 32,
wherein the plastic housing includes at least one thermally conductive adhesive and/or one thermally conductive foil which is or which may be situated, in particular adjacently, between the at least one section provided for heat dissipation and at least one galvanic cell.

43. The temperature-controlling plate as recited in claim 22,
wherein temperature-controlling plate is designed for controlling the temperature of two or more galvanic cells, wherein the two or more galvanic cells include at least one of galvanic cells of a battery module, >4 to <12 galvanic cells, and >6 to <8 galvanic cells.

44. The temperature-controlling plate as recited in claim 22, wherein the one or more galvanic cell(s) is at least one of a lithium cell, a lithium-ion cell, a lithium cell with a metallic shell, a lithium-ion cell with a metallic shell.

45. The temperature-controlling plate as recited in claim 23, wherein the one or multiple other material(s) include at least one of a plastic, a plastic compound, and a plastic-metal composite material.

46. The temperature-controlling plate as recited in claim 26, wherein the two or more galvanic cells include at least one of the galvanic cells of a battery module, ≧4 to ≦12 galvanic cells, and ≧6 to ≦8, galvanic cells.

47. The temperature-controlling plate as recited in claim 30, wherein the metallic line element is one of a wire and a mesh.

48. The plastic housing as recited in claim 32, wherein the one or more multiple galvanic cell(s) is at least one of a lithium cell and a lithium-ion cell.

49. The plastic housing as recited in claim 34, wherein the cover is a plate-shaped temperature-controlling plate.
